(19) United States
(12) Patent Application Publication
(10) Pub. No.: US 2014/0310731 A1
(43) Pub. Date: Oct. 16, 2014

(54) DISK DRIVE APPARATUS

(71) Applicant: Sony Corporation, Tokyo (JP)

(72) Inventors: Takeharu Takasawa, Kanagawa (JP); Takeshi Kubo, Kanagawa (JP); Naofumi Goto, Kanagawa (JP)

(73) Assignee: Sony Corporation, Tokyo (JP)

(21) Appl. No.: 14/221,312

(22) Filed: Mar. 21, 2014

(30) Foreign Application Priority Data
Apr. 12, 2013 (JP) 2013-083951

(51) Int. Cl. G11B 17/028; G11B 17/03

(52) U.S. Cl. CPC G11B 17/0284; G11B 17/03
USPC 720/604

(57) ABSTRACT

There is provided a disk drive apparatus including a first chassis unit that has a first pickup base at which a first optical pickup has been disposed, and a second chassis unit that has a second pickup base at which a pulley supporting part has been provided and at which a second optical pickup has been disposed. A disk table on which a disk-like recording medium is loaded is disposed at the first pickup base. A support hole is formed in the pulley supporting part. A chucking pulley that sandwiches and holds the disk-like recording medium together with the disk table is supported by the pulley supporting part in a state of being inserted in the support hole. At the chucking pulley, provided are an escape part, a flange part, and a clamp part.

### CROSS REFERENCE TO RELATED APPLICATIONS

This application claims the benefit of Japanese Priority Patent Application JP 2013-083951 filed Apr. 12, 2013, the entire contents of which are incorporated herein by reference.

### BACKGROUND

The present technology relates to a technical field relevant to a disk drive apparatus that sandwiches and holds a disk-like recording medium by a disk table and a chucking pulley and that performs recording or reproduction of an information signal to the disk-like recording medium rotated along with rotation of the disk table.

There are disk drive apparatuses that perform recording and reproduction of information signals of image data, voice data, etc. to disk-like recording media. Among such disk drive apparatuses, for example, there is included a disk drive apparatus that loads a double-sided disk in which recording and reproduction of an information signal can be performed to both sides, and performs recording and reproduction of the information signal to the both sides of the double-sided disk (for example, refer to JP H10-188456A).

The disk drive apparatus described in JP H10-188456A has: a first chassis at which a first optical pickup and a disk table have been arranged; and a second chassis at which a second optical pickup and a chucking pulley have been arranged. In the disk drive apparatus, when a disk cartridge is conveyed between the first chassis and the second chassis, the first chassis and the second chassis are moved in a direction of approaching to each other in a vertical direction according to operation of a slide cam plate, and a disk-like recording medium is chucked while being sandwiched by the disk table and the chucking pulley.

A biasing spring is provided at the chucking pulley, and a part of the chucking pulley is pressed against an inner periphery of the disk-like recording medium by a biasing force of the biasing spring at the time of chucking.

Recording or reproduction of an information signal is performed to the chucked disk-like recording medium by the first optical pickup and the second optical pickup that are moved in a radial direction of the disk-like recording medium. The first optical pickup is moved along a recording surface of the disk-like recording medium in a direction contacted and separated with/from the disk table, and the second optical pickup is moved along the recording surface of the disk-like recording medium in a direction contacted and separated with/from the chucking pulley.

### SUMMARY

By the way, in an apparatus in which recording or reproduction of an information signal is performed to both surfaces of a disk-like recording medium as the disk drive apparatus described in JP H10-188456A, in addition to an optical pickup (a first optical pickup) moved in a direction contacted and separated with/from a disk table, an optical pickup (a second optical pickup) moved in a direction contacted and separated with/from a chucking pulley is provided. In such disk drive apparatus compliant with a double-sided disk, it is desirable to achieve reduction in size after interference of the chucking pulley and the second optical pickup is avoided and a desired movement range of the second optical pickup is secured.

In addition, in the disk drive apparatus described in JP H10-188456A, such a configuration is employed that the biasing spring is provided at the chucking pulley, and that a part of the chucking pulley is pressed against the disk-like recording medium by the biasing spring, and there is a problem that a structure of the chucking pulley is complicated, and that manufacturing cost is high.

Consequently, it is desirable for a disk drive apparatus according to an embodiment of the present technology to overcome the above-described problem, and to achieve reduction in size and also simplification of the structure of the chucking pulley after interference of the chucking pulley and the second optical pickup is avoided and the desired movement range of the second optical pickup is secured.

According to an embodiment of the present disclosure, there is provided a disk drive apparatus including a first chassis unit that has a first pickup base at which a first optical pickup has been disposed, and a second chassis unit that has a second pickup base at which a pulley supporting part has been provided and at which a second optical pickup has been disposed. A disk table on which a disk-like recording medium is loaded is disposed at the first pickup base. A support hole is formed in the pulley supporting part. A chucking pulley that sandwiches and holds the disk-like recording medium together with the disk table is supported by the pulley supporting part in a state of being inserted in the support hole. At the chucking pulley, provided are an escape part to avoid interference with the second optical pickup, a flange part that is overhung outward from one end in an axial direction and that restricts fall-off from the support hole, and a clamp part that is overhung outward from another end in the axial direction and that is pressed against an inner periphery of the disk-like recording medium.

Consequently, interference of the chucking pulley and the second optical pickup is avoided by the escape part.

According to an embodiment of the present disclosure, at the chucking pulley, provided is an annular inflow air control part that is located in the support hole and that controls the air made to flow in the support hole in a state where the disk-like recording medium is sandwiched by the disk table and the chucking pulley.

Consequently, an air flow brought into the support hole is rectified around the chucking pulley.

According to an embodiment of the present disclosure, the escape part and the clamp part may be made removable. A diameter of the escape part may be made smaller than a diameter of the support hole. An outer shape of the clamp part may be made larger than the diameter of the support hole.

Consequently, the escape part is inserted in the support hole in a state where the escape part and the clamp part are separated from each other, and the clamp part is connected to the escape part, whereby the chucking pulley is supported by the pulley supporting part.

According to an embodiment of the present disclosure, the escape part may be formed in a cylindrical shape or a columnar shape that extends in a thickness direction of the disk-like recording medium. A circular arc-shaped escape concave part that is opposed to the escape part may be formed in the second optical pickup.

Consequently, when the second optical pickup is moved to an inner peripheral side of the disk-like recording medium, a part of the escape part is inserted in the escape concave part.

According to an embodiment of the present disclosure, the flange part and the inflow air control part may be integrally formed.

Consequently, the flange part and the inflow air control part do not have to be provided as separate components.

According to an embodiment of the present disclosure, the inflow air control part and the escape part may be integrally formed.

Consequently, the inflow air control part and the escape part do not have to be provided as separate components.

According to the present technology, reduction in size can be achieved and also simplification of the structure of the chucking pulley can be achieved, after interference of the chucking pulley and the second optical pickup is avoided and the desired movement range of the second optical pickup is secured.

### BRIEF DESCRIPTION OF THE DRAWINGS

FIG. 1 shows a mode for carrying out a disk drive apparatus according to an embodiment of the present technology together with FIGS. 2 to 22, and the present drawing is a perspective view of the disk drive apparatus;

FIG. 2 is an exploded perspective view of the disk drive apparatus;

FIG. 3 is an exploded perspective view of a first chassis unit;

FIG. 4 is a perspective view of the first chassis unit;

FIG. 5 is a schematic enlarged cross-sectional view showing together with a disk table a state where a chucking pulley is supported by a pulley supporting part;

FIG. 6 is an exploded perspective view of the second chassis unit;

FIG. 7 is a perspective view of the second chassis unit;

FIG. 8 is a plan view of the disk drive apparatus;

FIG. 9 is an enlarged exploded perspective view of the chucking pulley;

FIG. 10 is an enlarged perspective view of the chucking pulley;

FIG. 11 is a perspective view of a cam slider;

FIG. 12 shows operation of the disk drive apparatus together with FIGS. 13 to 22, and the present figure is a schematic side view showing an initial state;

FIG. 13 is a schematic cross-sectional view showing the initial state;

FIG. 14 is a perspective view showing a state where a disk-like recording medium has been conveyed in the initial state;

FIG. 15 is a schematic cross-sectional view showing a state where the disk-like recording medium has been conveyed to a chucking position;

FIG. 16 is a schematic side view showing a half-way state where the first chassis unit and the second chassis unit are moved in a vertical direction;

FIG. 17 is a schematic cross-sectional view showing the half-way state where the first chassis unit and the second chassis unit are moved in the vertical direction;

FIG. 18 is a schematic side view showing a state where the first chassis unit and the second chassis unit have been moved in the vertical direction, and where a first rectifying plate part and a second rectifying plate part have been connected to each other;

FIG. 19 is a perspective view showing a state where the first chassis unit and the second chassis unit have been moved in the vertical direction, and where the first rectifying plate part and the second rectifying plate part have been connected to each other;

FIG. 20 is a schematic enlarged cross-sectional view showing a state where the first chassis unit and the second chassis unit have been moved in the vertical direction, and where the disk-like recording medium has been chucked;

FIG. 21 is a perspective view showing as a cross section a part of a state where the first chassis unit and the second chassis unit have been moved in the vertical direction, and where the disk-like recording medium has been chucked; and

FIG. 22 is an enlarged plan view showing a state where a second optical pickup has been moved to an inner peripheral side of the disk-like recording medium, and where a part of an escape part of the chucking pulley has been inserted in an escape concave part formed in the second optical pickup.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment of a disk drive apparatus according to an embodiment of the present technology will be explained according to accompanying drawings.

In the following explanation, a direction where a disk-like recording medium is conveyed toward the disk drive apparatus at the time of loading is set as a rear (a retraction direction), a direction where the disk-like recording medium is conveyed from the disk drive apparatus at the time of ejection is set as a front (discharge direction), and a horizontal direction is indicated in a state when the disk drive apparatus is seen from the front, whereby the front/rear, vertical, and horizontal directions are indicated.

Note that the front/rear, vertical, and horizontal directions indicated hereinafter are for convenience of explanation, and that the carrying out of the present technology is not limited to these directions.

### [Configuration of Disk Drive Apparatus]

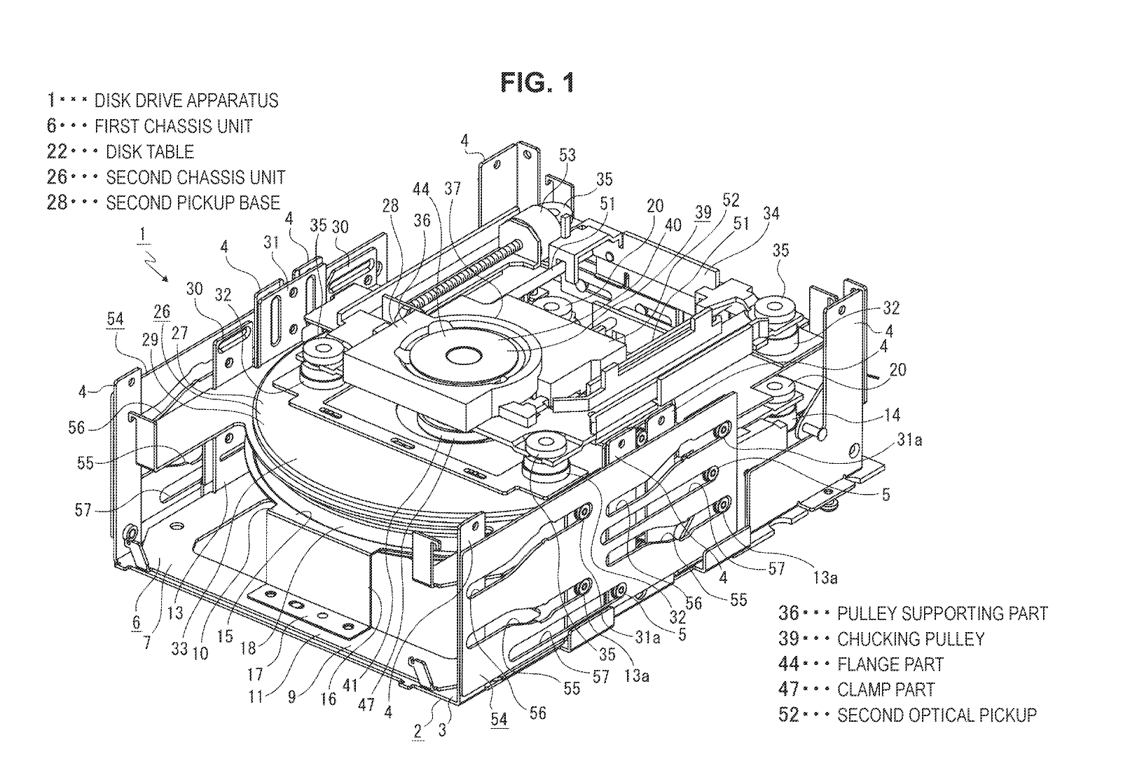

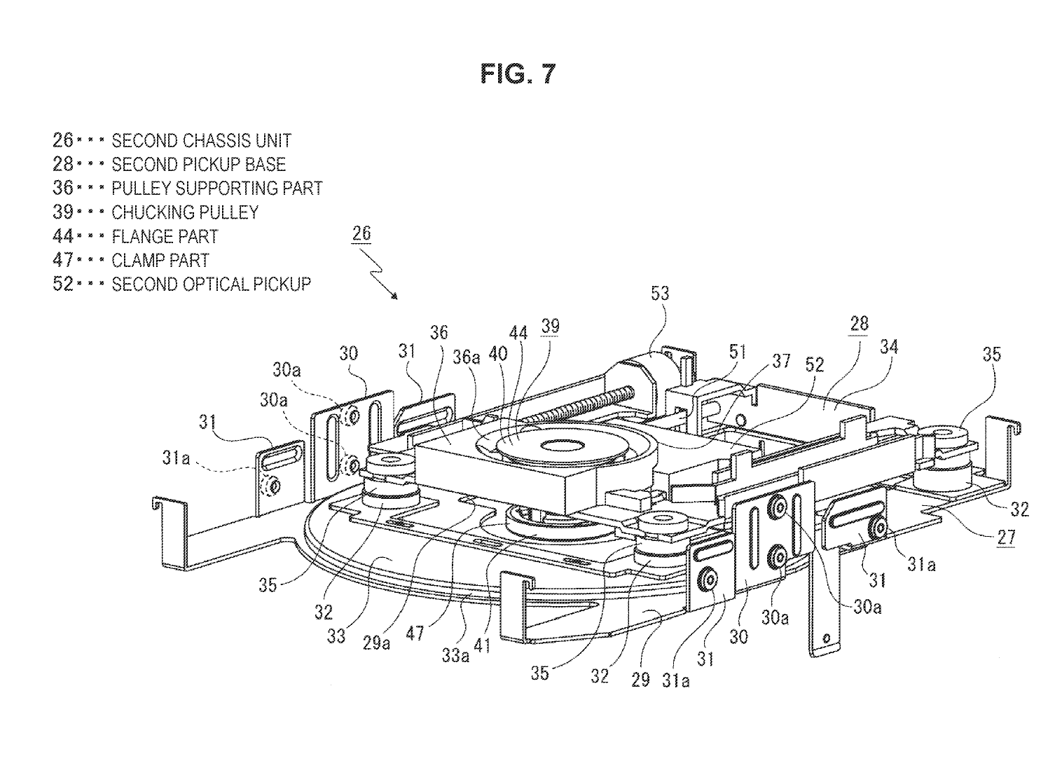

First, a specific configuration of a disk drive apparatus 1 will be explained (refer to FIGS. 1 to 8).

### <Base Frame>

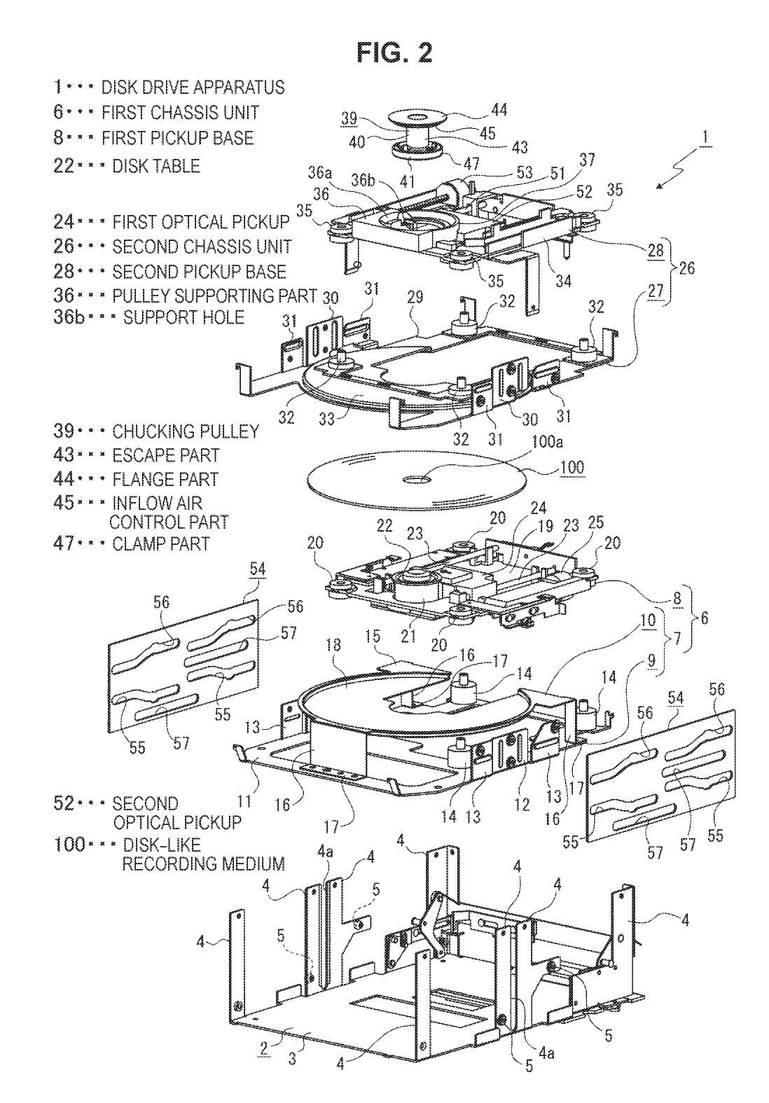

The disk drive apparatus 1 has: a base frame 2; and a cover to cover the base frame 2 from an upper side, which is not shown, and the base frame 2 has: a bottom surface plate part 3 formed in substantially a rectangle having an elongated outer shape; and a plurality of side surface plate parts 4, 4, . . . projected upward from both right and left edges of the bottom surface plate part 3, respectively (refer to FIGS. 1 and 2).

At both right and left sides of substantially a center in a front/rear direction of the base frame 2, a pair of side surface plate parts 4, 4, . . . are provided side by side at front and rear sides. A slit that is opened upward and vertically extends is formed between these side surface plate parts 4 and 4 aligned at the front and rear sides, and this slit is formed as a guidance restriction hole 4a.

Guidance restriction pins 5, 5, . . . are attached to outer surfaces of the side surface plate parts 4, 4, . . . aligned in pairs at the front and rear sides in substantially the center in the front/rear direction, respectively.

### <First Chassis Unit>

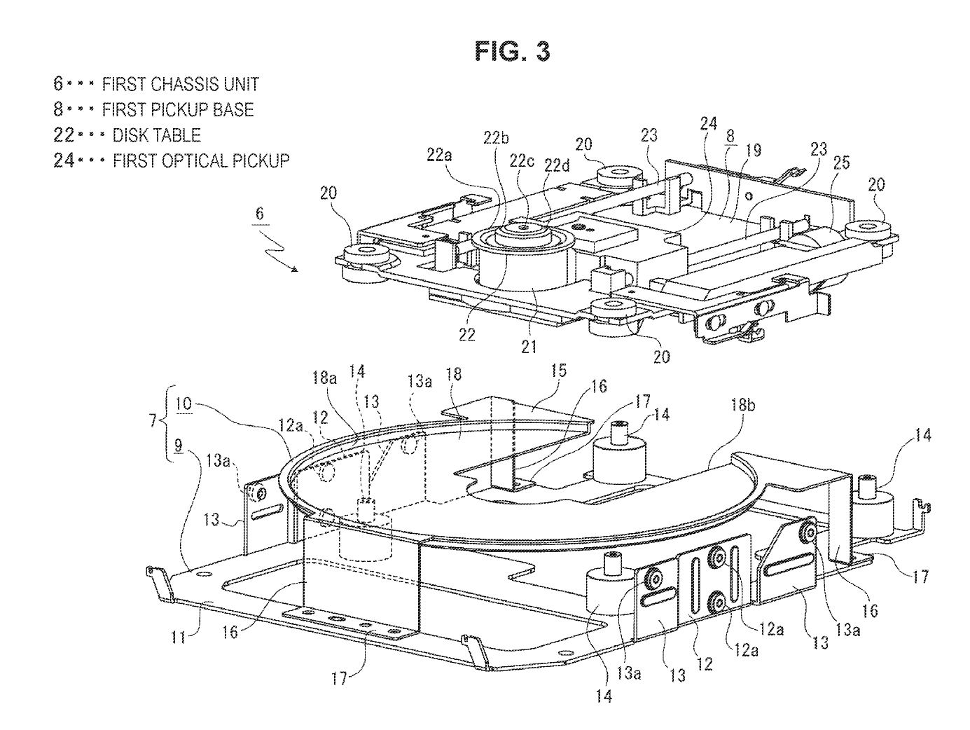

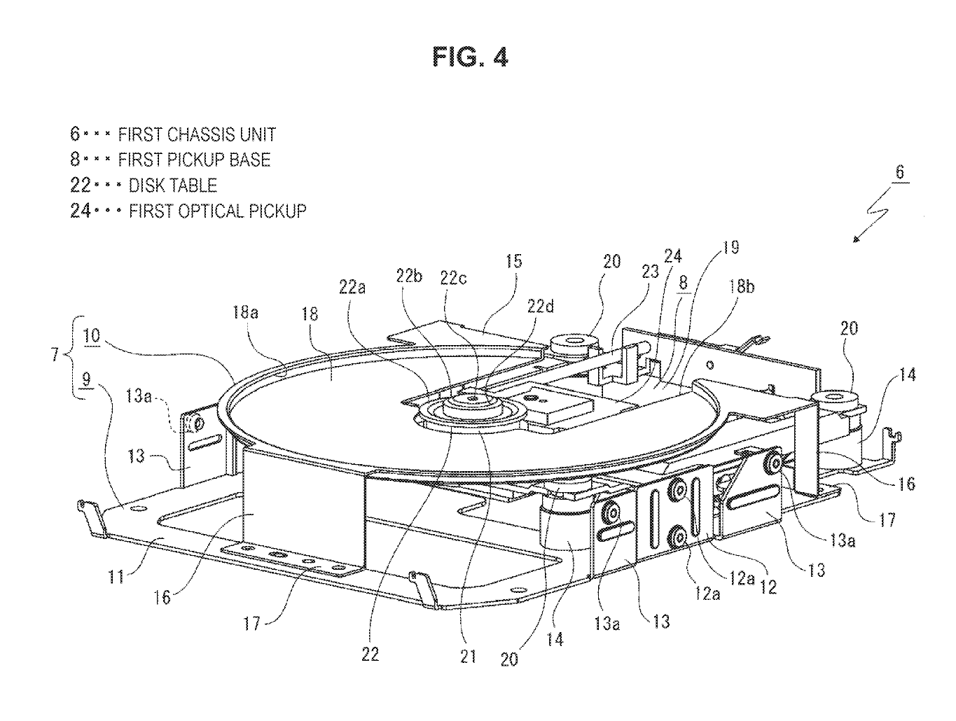

A first chassis unit 6 is movably supported in a vertical direction by the side surface plate parts 4, 4, . . . of the base frame 2. The first chassis unit 6 has a first base chassis 7 and a first pickup base 8 (refer to FIGS. 3 and 4).

In the first base chassis 7, a disk plate 10 is connected to a base plate 9.

The base plate 9 has: a base surface part 11 that faces the vertical direction; first side surface parts 12 and 12 projected upward from both right and left edges of the base surface part 11, respectively; and second side surface parts 13, 13, . . . projected upward from both the right and left edges of the base surface part 11, respectively.

The base surface part 11 is formed in an elongated substantially rectangular shape.

The first side surface part 12 is located slightly closer to an inside than the second side surface part 13, and guided pins 12a and 12a are provided at an outer surface of the first side surface part 12 so as to be vertically spaced aside from each other. The guided pins 12a and 12a are vertically slidably engaged with the guidance restriction hole 4a formed between the side surface plate parts 4 and 4 of the base frame 2, and movement to a horizontal direction of the base plate 9 is restricted by the base frame 2.

The second side surface parts 13, 13, . . . are located at front and rear sides sandwiching the first side surface parts 12 and 12, respectively. A guided pin 13a is provided at an outer surface of the second side surface part 13.

Upwardly projected four attachment projections 14, 14, . . . are provided on the base surface part 11 so as to be spaced aside from one another in all directions.

The disk plate 10 includes: an upper surface plate part 15 that faces the vertical direction; coupling plate parts 16, 16, and 16 respectively projected downward from an outer periphery of the upper surface plate part 15; and attached plate parts 17, 17, and 17 provided continuously with lower ends of the coupling plate parts 16, 16, and 16. A first rectifying plate part 18 formed having a circular arc outer shape is provided at the upper surface plate part 15, and an outer periphery of the first rectifying plate part 18 is provided as an upwardly folded first folded part 18a. A transmission notch 18b is formed at a position from the outer periphery to a center of the first rectifying plate part 18.

In the disk plate 10, the attached plate parts 17, 17, and 17 are attached to the outer periphery of the base surface part 11, and are connected to the base plate 9. In a state where the disk plate 10 has been connected to the base plate 9, the upper surface plate part 15 is located in a state of being parallel to the base surface part 11.

The first pickup base 8 is attached to the base surface part 11 of the base plate 9 through the attachment projections 14, 14, . . . Desired each part of the first pickup base 8 is arranged at an arrangement plate 19.

The arrangement plate 19 is formed in an elongated substantially rectangular shape, and insulators 20, 20, . . . are connected to four corners thereof. The insulators 20, 20, . . . are attached to the attachment projections 14, 14, . . . , respectively, and thereby the first pickup base 8 is connected to the first base chassis 7. The first pickup base 8 is located below the first rectifying plate part 18 of the disk plate 10 in a state of being connected to the first base chassis 7.

A spindle motor 21 is arranged at one end in a longitudinal direction of the arrangement plate 19, and a disk table 22 is coupled to an output shaft of the spindle motor 21. Accordingly, the disk table 22 is rotated by a drive force of the spindle motor 21.

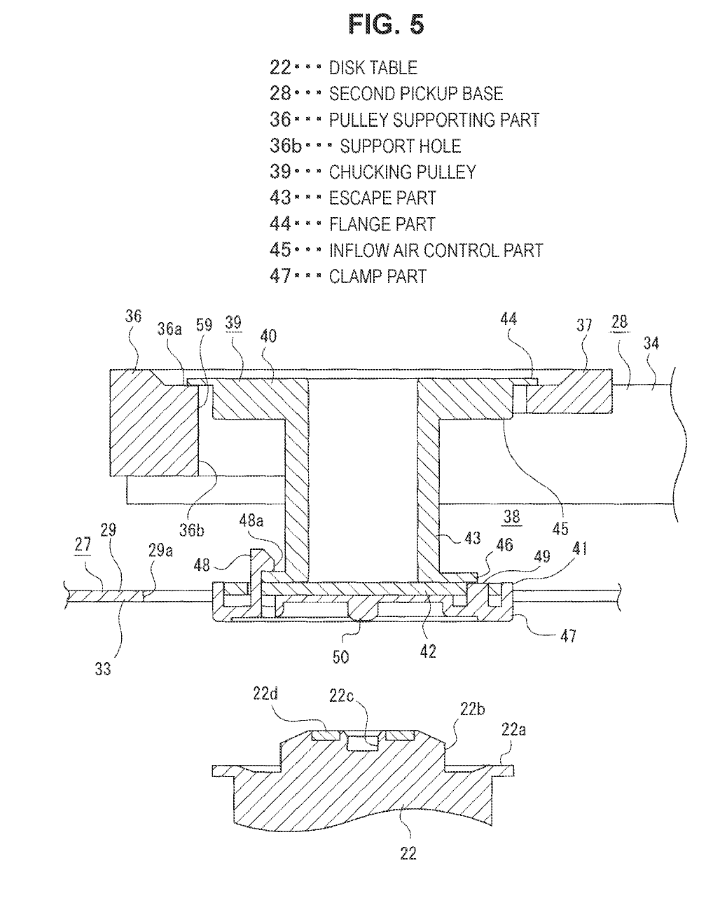

An outer periphery of the disk table 22 is provided as a table part 22a, and an inside portion of the table part 22a is provided as an upwardly projected centering projection 22b (refer to FIG. 5). An upwardly opened positioning concave part 22c is formed in a central portion of the centering projection 22b. For example, a metal plate 22d formed in an annular shape is embedded in the centering projection 22b.

Guide shafts 23 and 23 that extend in the longitudinal direction are arranged at the arrangement plate 19 so as to be spaced aside from each other at right and left sides. A first optical pickup 24 is movably supported by the guide shafts 23 and 23.

A drive motor 25 is arranged at the arrangement plate 19. The drive motor 25 has a lead screw that extends in the front/rear direction, and the lead screw is screwed to a part of the first optical pickup 24. Accordingly, the first optical pickup 24 is guided by the guide shafts 23 and 23 by means of a drive force of the drive motor 25, and is moved in a direction contacted and separated with/from the disk table 22 (in the front/rear direction). When the first optical pickup 24 is moved, a light emitted from the first optical pickup 24 to a disk-like recording medium 100 is irradiated to the disk-like recording medium 100 through the transmission notch 18b formed at the first rectifying plate part 18.

### <Second Chassis Unit>

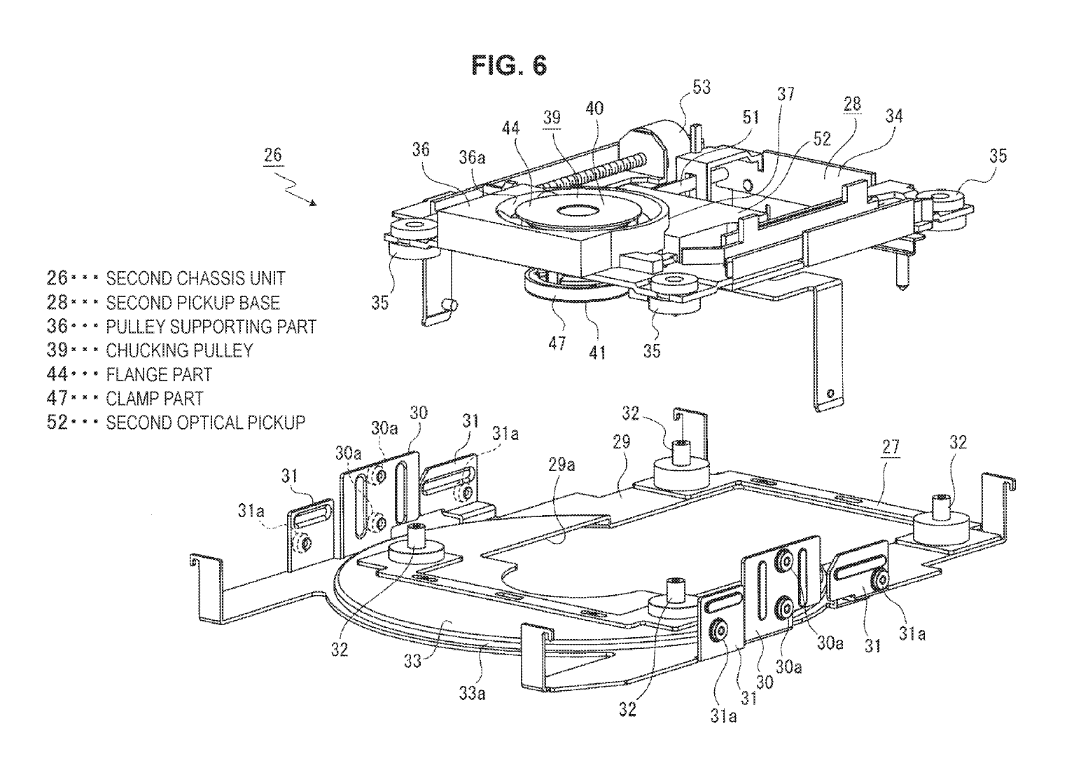

A second chassis unit 26 is supported movably in the vertical direction above the first chassis unit 6 by the side surface plate parts 4, 4, . . . of the base frame 2 (refer to FIGS. 2 and 3). The second chassis unit 26 has a second base chassis 27 and a second pickup base 28 (refer to FIGS. 6 to 8).

The second base chassis 27 has: a base surface part 29 formed in an elongated substantially rectangular shape; first side surface parts 30 and 30 projected upward from both right and left edges of the base surface part 29, respectively; and second side surface parts 31, 31, . . . projected upward from both the right and left edges of the base surface part 29, respectively.

A vertically penetrated transmission hole 29a is formed in the base surface part 29.

The first side surface part 30 is located slightly closer to an inside than the second side surface part 31, and guided pins 30a and 30a are provided at an outer surface of the first side surface part 30 so as to be vertically spaced aside from each other. The guided pins 30a and 30a are vertically slidably engaged with the guidance restriction hole 4a formed between the side surface plate parts 4 and 4 of the base frame 2, and movement to the horizontal direction of the second base chassis 27 is restricted by the base frame 2.

The second side surface parts 31, 31, . . . are located at front and rear sides sandwiching the first side surface parts 30 and 30, respectively. A guided pin 31a is provided at an outer surface of the second side surface part 31.

Upwardly projected four attachment projections 32, 32, . . . are provided on the base surface part 29 so as to be spaced aside from one another in all directions.

A part of the second base chassis 27 is provided as a second rectifying plate part 33, and the second rectifying plate part 33 is a portion located right above the first rectifying plate part 18 of the first base chassis 7. A part of the transmission hole 29a is located also in the second rectifying plate part 33. An outer periphery of the second rectifying plate part 33 is provided as a downwardly folded second folded part 33a.

The second pickup base 28 is attached to the base surface part 29 of the second base chassis 27 through the attachment projections 32, 32, . . . Desired each part of the second pickup base 28 is arranged at an arrangement plate 34.

The arrangement plate 34 is formed in an elongated substantially rectangular shape, and insulators 35, 35, . . . are connected to four corners thereof. The insulators 35, 35, . . . are attached to the attachment projections 32, 32, . . . , respectively, and thereby the second pickup base 28 is connected to the second base chassis 27. The second pickup base 28 is located above the second rectifying plate part 33 of the second base chassis 27 in a state of being connected to the second base chassis 27.

A pulley supporting part 36 is provided at one end in the longitudinal direction of the arrangement plate 34. The pulley supporting part 36 is formed in a vertically penetrated annular shape, and a part thereof is formed in a circular arc shape. An upwardly opened annular receiving concave part 36a is formed in an upper end of the pulley supporting part 36, and a vertically penetrated support hole 36b is formed inside the receiving concave part 36a of the pulley supporting part 36 (refer to FIG. 5).

A rear end portion of the pulley supporting part 36 is provided as a projection 37 projected rearward with respect to an other portion, and a thickness in the vertical direction of the projection 37 is made smaller than a thickness in the vertical direction of the other portion. The projection 37 is projected rearward from an upper end of the other portion. Accordingly, a space is formed under the projection 37, and this space is formed as a movement space 38.

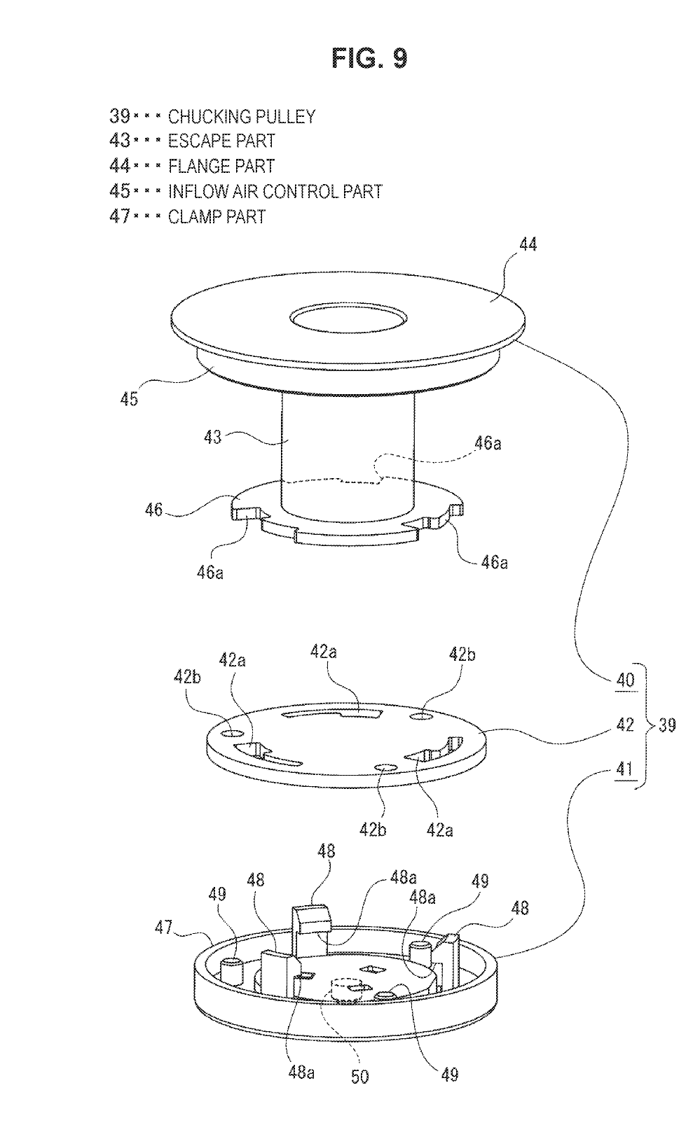

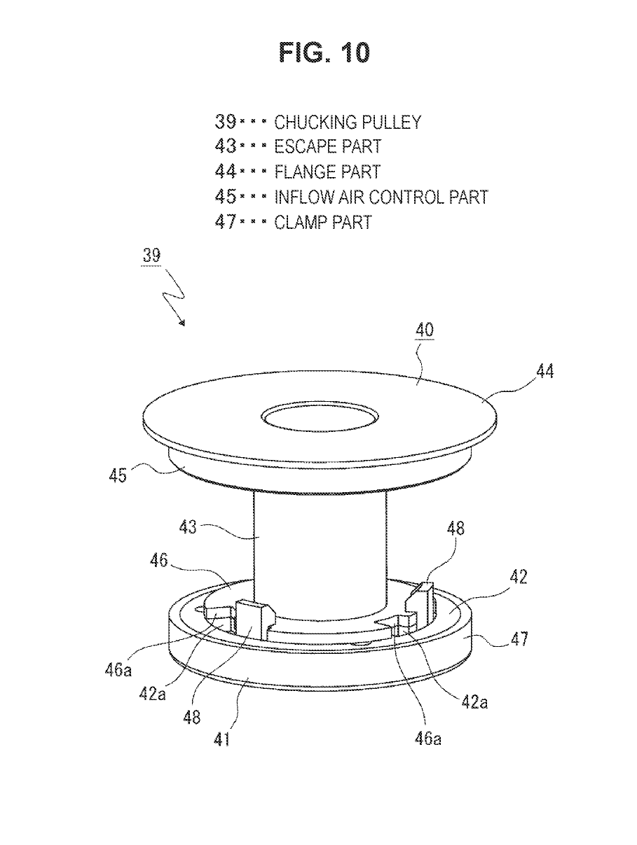

A chucking pulley 39 is rotatably supported by the pulley supporting part 36. In the chucking pulley 39, a pulley body 40, a clamper 41, and a magnet 42 are connected to one another (refer to FIGS. 9 and 10).

In the pulley body 40, integrally formed are: a cylindrical or columnar escape part 43 that vertically extends; a flange part 44 overhung outward from an upper end of the escape part 43; an inflow air control part 45 overhung outward from a portion closer to the upper end of the escape part 43; and a connection plate part 46 overhung outward from a lower end of the escape part 43.

In the escape part 43, a length in an axial direction (vertical direction) is made longer, and the length in the axial direction is made longer than a thickness in the vertical direction of the second optical pickup, which will be mentioned later.

An outer diameter of the flange part 44 is made larger than an outer diameter of the inflow air control part 45 and a diameter of the support hole 36b formed in the pulley supporting part 36 of the second pickup base 28, and a thickness of the flange part 44 is made smaller than a thickness of the inflow air control part 45 and smaller than a depth of the receiving concave part 36a formed in the pulley supporting part 36 of the second pickup base 28. The outer diameter of the inflow air control part 45 is made smaller than the diameter of the support hole 36b.

Outer shapes of the escape part 43, the flange part 44, and the inflow air control part 45 are all formed in circles. Connection notches 46a, 46a, and 46a are formed at an outer periphery of the connection plate part 46 so as to be spaced aside from one another at regular intervals in a peripheral direction.

In the clamper 41, integrally formed are: a clamp part 47 formed in a shallow container shape that is opened upward; connection projections 48, 48, and 48 projected upward from a bottom surface of the clamp part 47; connection shaft parts 49, 49, and 49 projected upward from the bottom surface of the clamp part 47; and a positioning projection 50 projected downward from a lower surface of the clamp part 47.

An outer shape of the clamp part 47 in a horizontal cross section is formed in a circle. The connection projections 48, 48, and 48 are provided spaced aside from one another at regular intervals in the peripheral direction. The connection projection 48 has an engagement claw part 48a at an upper end thereof. The connection shaft parts 49, 49, and 49 are located among the connection projections 48, 48, and 48, respectively, and are provided spaced aside from one another at regular intervals in the peripheral direction. The positioning projection 50 is projected downward from a central portion of the clamp part 47.

An outer diameter of the clamp part 47 is made larger than the diameter of the support hole 36b formed in the pulley supporting part 36 of the second pickup base 28.

The magnet 42 is formed in a circular plate shape, and has connection holes 42a, 42a, and 42a that are formed spaced aside from one another at regular intervals in the peripheral direction. In the magnet 42, shaft insertion holes 42b, 42b, and 42b are formed among the connection holes 42a, 42a, and 42a, respectively so as to be spaced aside from one another in the peripheral direction.

The connection projections 48, 48, and 48 are inserted in the connection holes 42a, 42a, and 42a, respectively, and also the connection shaft parts 49, 49, and 49 are inserted in the shaft insertion holes 42b, 42b, and 42b, respectively, whereby the magnet 42 is connected to the clamper 41.

The engagement claw parts 48a, 48a, and 48a of the connection projections 48, 48, and 48 are engaged with opening edges of the connection notches 46a, 46a, and 46a in the connection plate part 46, respectively in a state where the magnet 42 is connected to the clamper 41, and thereby the clamper 41 and the pulley body 40 are connected to each other to configure the chucking pulley 39. The magnet 42 is vertically sandwiched and held by the connection plate part 46 and the clamp part 47 of the pulley body 40.

The escape part 43 and the inflow air control part 45 of the pulley body 40 are inserted in the support hole 36b from an upper side in a state where the clamper 41 to which the magnet 42 has been connected and the pulley body 40 are separated from each other, and the pulley body 40 and the clamper 41 to which the magnet 42 has been connected are connected to each other, whereby the chucking pulley 39 is supported by the pulley supporting part 36 rotatably in a shaft rotation direction and movably in the vertical direction (refer to FIG. 5). In a state where the chucking pulley 39 is supported by the pulley supporting part 36, a lower surface of the flange part 44 gets contact with a bottom surface of the receiving concave part 36a due to its own weight.

Guide shafts 51 and 51 that extend in the longitudinal direction are arranged at the arrangement plate 34 so as to be spaced aside from each other at right and left sides (refer to FIGS. 6 to 8).

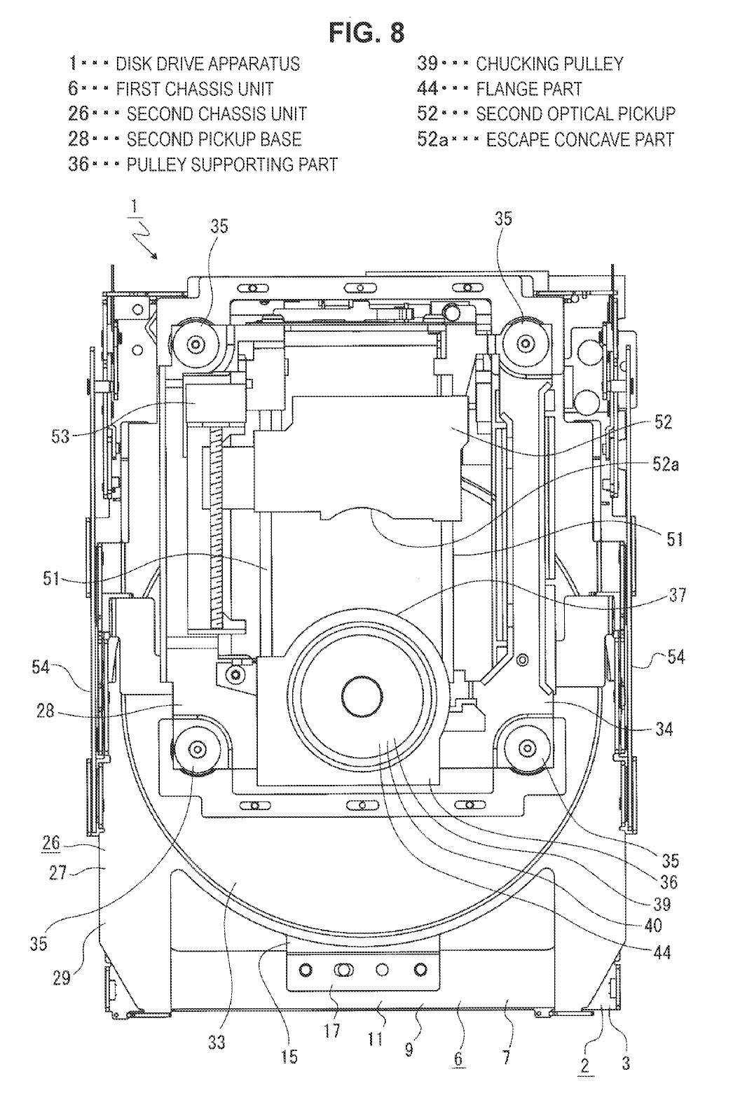

A second optical pickup 52 is movably supported by the guide shafts 51 and 51. A forwardly opened escape concave part 52a is formed in the second optical pickup 52 (refer to FIG. 8). The escape concave part 52a is formed in a circular arc shape, and a radius of curvature thereof is made slightly larger than a radius of curvature of the escape part 43 in the chucking pulley 39.

A drive motor 53 is arranged at the arrangement plate 34. The drive motor 53 has a lead screw that extends in the front/rear direction, and the lead screw is screwed to a part of the second optical pickup 52. Accordingly, the second optical pickup 52 is guided by the guide shafts 51 and 51 by means of a drive force of the drive motor 53, and is moved in a direction contacted and separated with/from the chucking pulley 39 (in the front/rear direction). When the second optical pickup 52 is moved, a light emitted from the second optical pickup 52 to the disk-like recording medium 100 is irradiated to the disk-like recording medium 100 through the transmission hole 29a formed in the base surface part 29 of the second base chassis 27.

### <Cam Slider>

Cam sliders 54 and 54 are movably supported in the front/rear direction by the side surface plate parts 4, 4, . . . of the base frame 2, respectively (refer to FIGS. 1 and 2). The cam slider 54 is formed in a plate shape that faces the horizontal direction, and is moved in the front/rear direction by a drive mechanism, which is not shown.

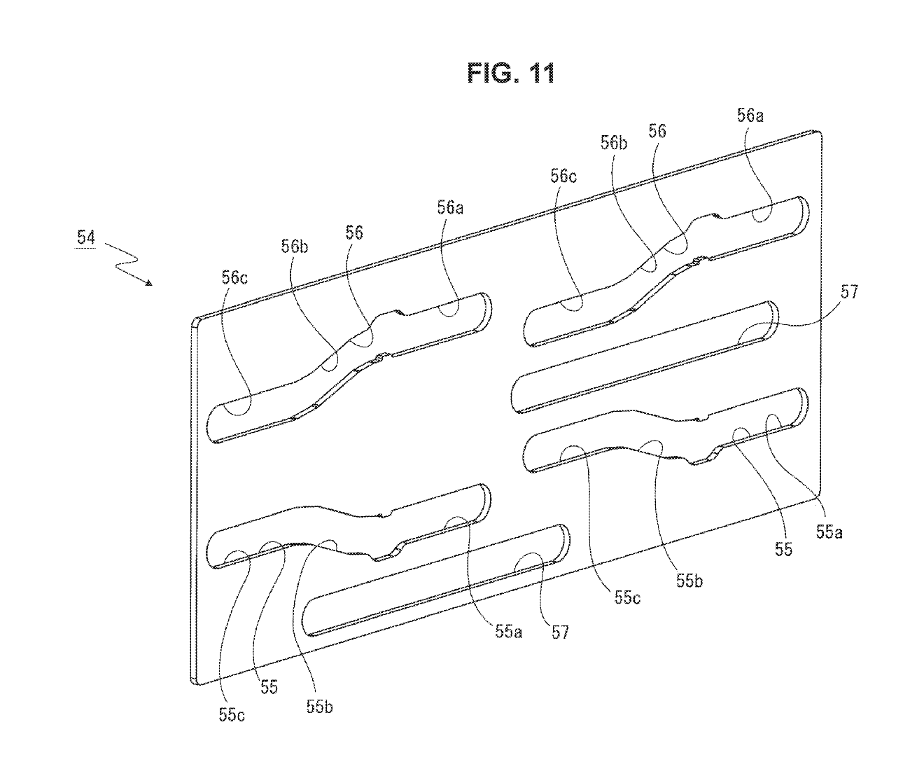

First cam holes 55 and 55 are formed in the cam slider 54 so as to be spaced aside from each other at front and rear sides (refer to FIG. 11). The first cam hole 55 includes: a rear cam part 55a that extends in the front/rear direction; an inclined cam part 55b that is continuous with a front end of the rear cam part 55a and is displaced more upward toward the front; and a front cam part 55c that is continuous with a front end of the inclined cam part 55b and extends in the front/rear direction.

In the cam slider 54, second cam holes 56 and 56 are formed above the first cam holes 55 and 55, respectively so as to be spaced aside from each other at front and rear sides. The second cam hole 56 includes: a rear cam part 56a that extends in the front/rear direction; an inclined cam part 56b that is continuous with a front end of the rear cam part 56a and is displaced more downward toward the front; and a front cam part 56c that is continuous with a front end of the inclined cam part 56b and extends in the front/rear direction.

In the cam slider 54, guided holes 57 and 57 that extend in the front/rear direction are formed at a lower side of the front first cam hole 55 and an upper side of the rear first cam hole 55, respectively.

The guidance restriction pins 5 and 5 of the base frame 2 are inserted in the guided holes 57 and 57, respectively, and thereby the cam slider 54 is supported movably in the front/rear direction with respect to the base frame 2.

The guided pins 13a and 13a of the first chassis unit 6 are slidably engaged with the first cam holes 55 and 55 of the cam slider 54, respectively, and the first chassis unit 6 is supported movably in the vertical direction by the cam sliders 54 and 54.

The guided pins 31a and 31a of the second chassis unit 26 are slidably engaged with the second cam holes 56 and 56 of the cam slider 54, respectively, and the second chassis unit 26 is supported movably in the vertical direction by the cam sliders 54 and 54.

Accordingly, when the cam sliders 54 and 54 are moved in the front/rear direction, the guided pins 12a and 12a are guided to the guidance restriction hole 4a of the base frame 2, the guided pins 13a and 13a are slid in the first cam holes 55 and 55 of the cam slider 54 and the first chassis unit 6 is moved in the vertical direction, and also the guided pins 31a and 31a are slid in the second cam holes 56 and 56 of the cam slider 54 and the second chassis unit 26 is moved in the vertical direction.

### [Operation of Disk Drive Apparatus]

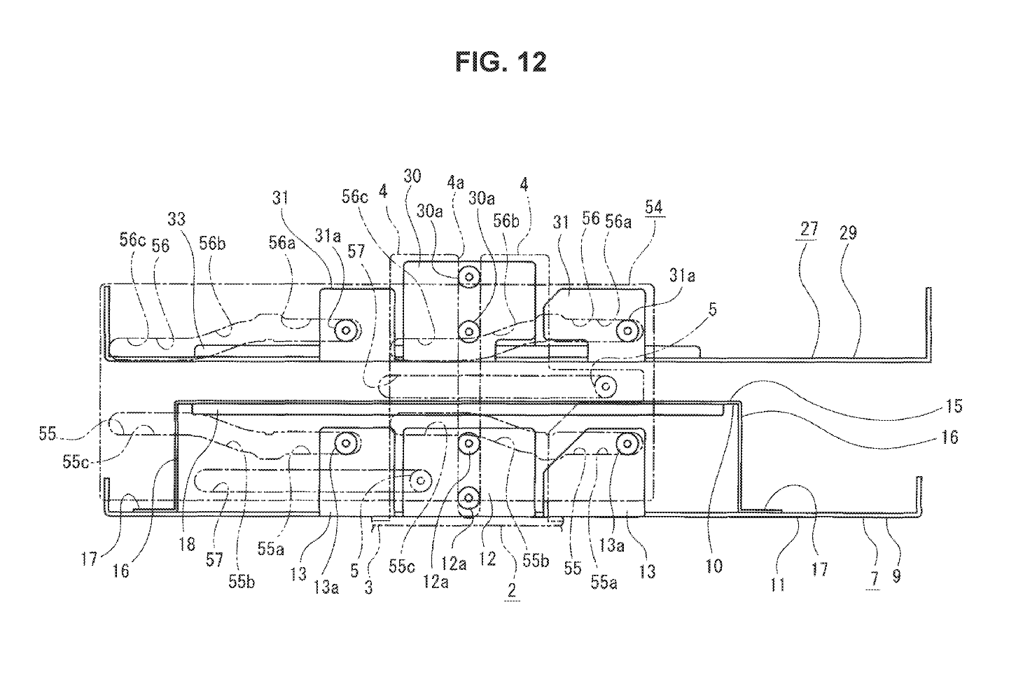

Hereinafter, will be explained operation of the disk drive apparatus 1 to the disk-like recording medium 100 at the time of chucking (refer to FIGS. 12 to 22).

### <Outline of Operation>

First, an outline of operation relating to chucking operation will be explained.

The disk-like recording medium 100 is ejected from a disk cartridge, which is not shown, is conveyed in a retraction direction (rearward) to a chucking position in the disk drive apparatus 1 by loading operation of a conveyance device, which is not shown, and is chucked at the chucking position, and recording or reproduction of an information signal is performed. In addition, when recording or reproduction of the information signal is ended, chucking of the disk-like recording medium 100 is released, and the disk-like recording medium 100 is conveyed in a discharge direction (forward) by eject operation of the conveyance device and is stored in the disk cartridge.

Note that conveyance of the disk-like recording medium 100 is, for example, performed in a state where the disk-like recording medium 100 is held by a disk holding part provided at a conveyance device.

### <Initial State>

Next, will be explained an initial state of each part in the disk drive apparatus 1 at the time of chucking operation (refer to FIGS. 12 to 14).

The cam sliders 54 and 54 are held at front movable ends, respectively. At this time, the guidance restriction pins 5 and 5 of the base frame 2 are engaged with rear ends of the guided holes 57 and 57 in the cam slider 54, respectively. In addition, the guided pins 13a and 13a of the first chassis unit 6 are engaged with rear ends of the rear cam parts 55a and 55a of the first cam holes 55 and 55 in the cam slider 54, respectively, and the guided pins 31a and 31a of the second chassis unit 26 are engaged with rear ends of the rear cam parts 56a and 56a of the second cam holes 56 and 56 in the cam slider 54, respectively.

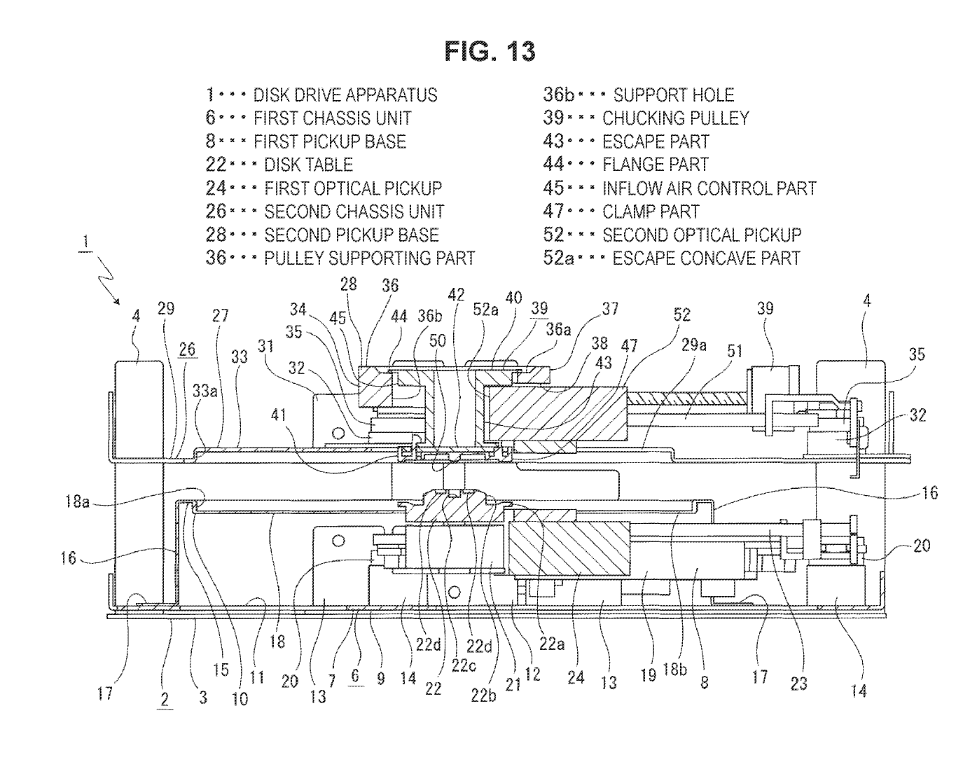

Accordingly, the first chassis unit 6 is held at a lower movable end, and the second chassis unit 26 is held at an upper movable end. The first chassis unit 6 is held at the lower movable end, and the second chassis unit 26 is held at the upper movable end, whereby the first rectifying plate part 18 of the first base chassis 7 and the second rectifying plate part 33 of the second base chassis 27 are located most spaced aside from each other in the vertical direction (refer to FIGS. 12 and 13). In addition, the disk table 22 and the chucking pulley 39 are located most spaced aside from each other in the vertical direction.

### <Chucking Operation>

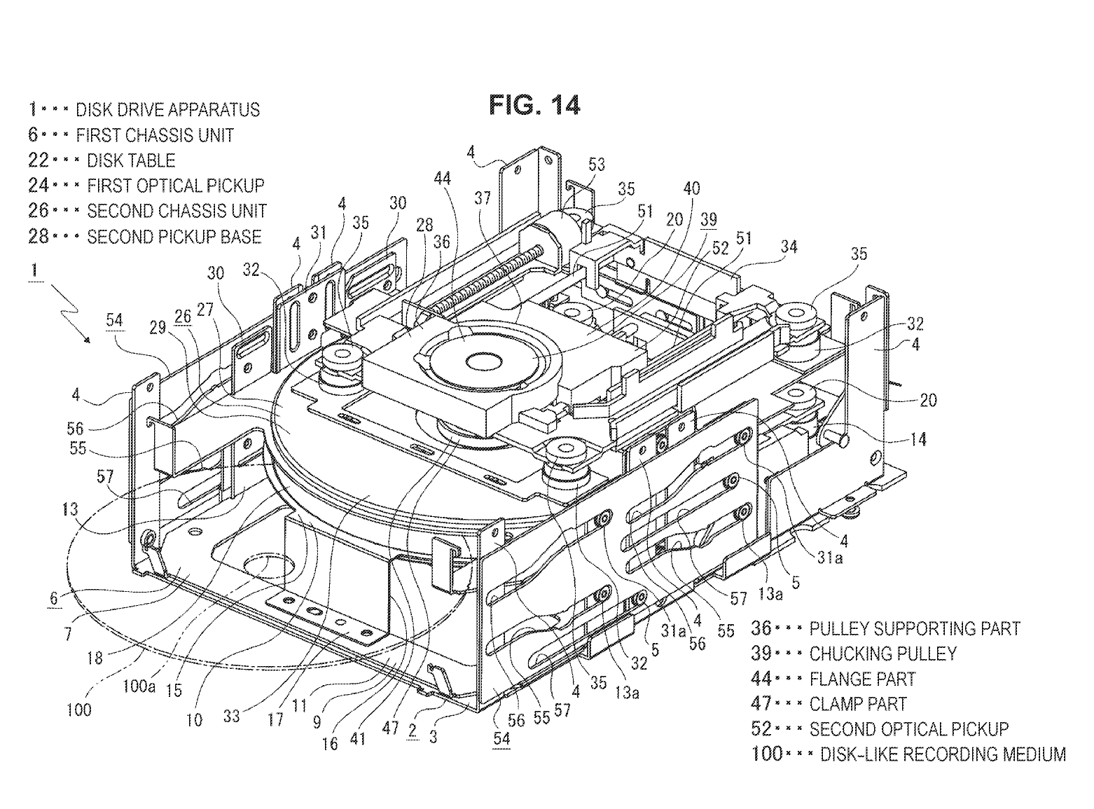

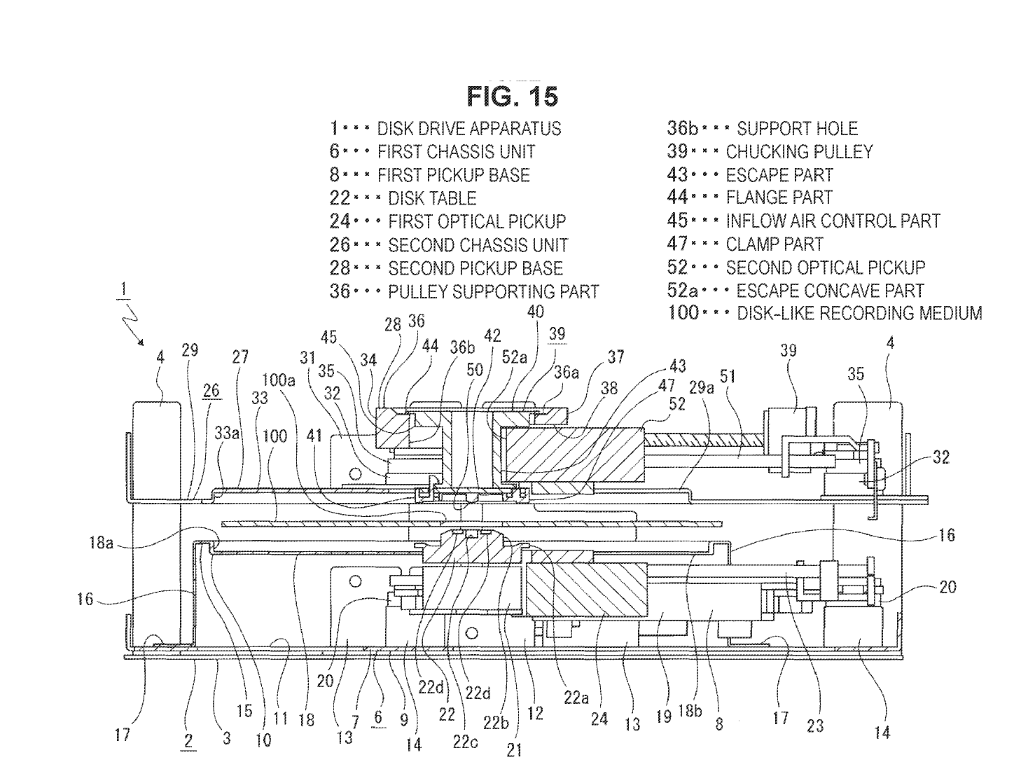

The disk-like recording medium 100 is ejected from the disk cartridge, and is conveyed in the retraction direction (rearward) by the loading operation of the conveyance device (refer to FIG. 14). The disk-like recording medium 100 is conveyed to a chucking position where a center of a center hole 100a coincides with a center axis of the disk table 22 and a center axis of the chucking pulley 39 (refer to FIG. 15).

In a state where the disk-like recording medium 100 has been conveyed to the chucking position, the disk-like recording medium 100 is located right above the first rectifying plate part 18 of the first chassis unit 6, and is also located right under the second rectifying plate part 33 of the second chassis unit 26. At this time, the disk-like recording medium 100 is held by the disk holding part of the conveyance device.

When the disk-like recording medium 100 is conveyed to the chucking position, the cam sliders 54 and 54 are synchronously moved rearward by the drive mechanism. Since the guidance restriction pins 5 and 5 of the base frame 2 are engaged with the guided holes 57 and 57, respectively, the cam slider 54 is guided by the guidance restriction pins 5 and 5, and is moved rearward.

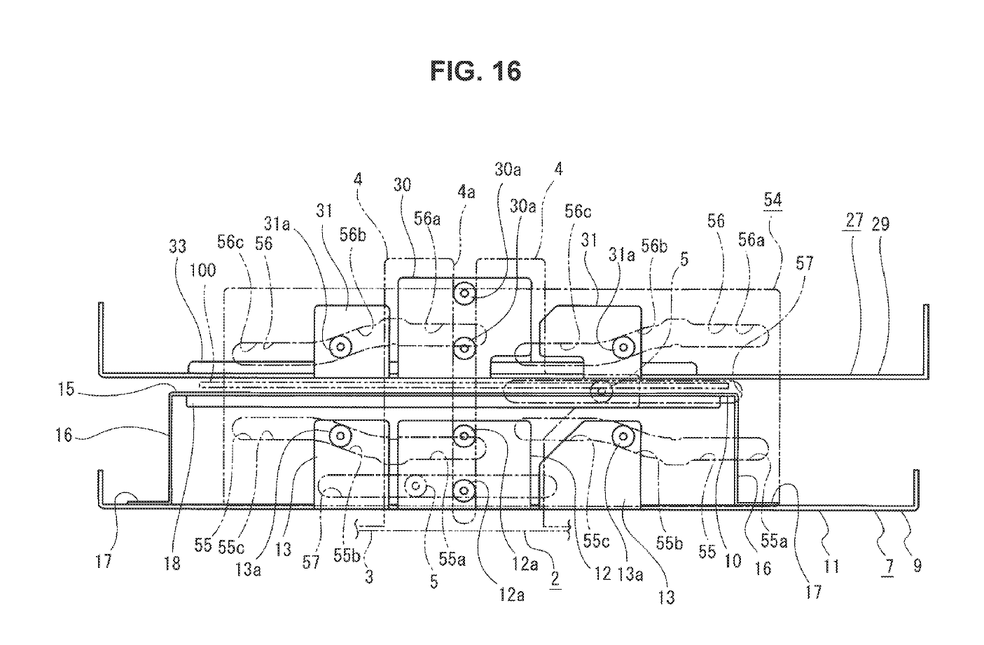

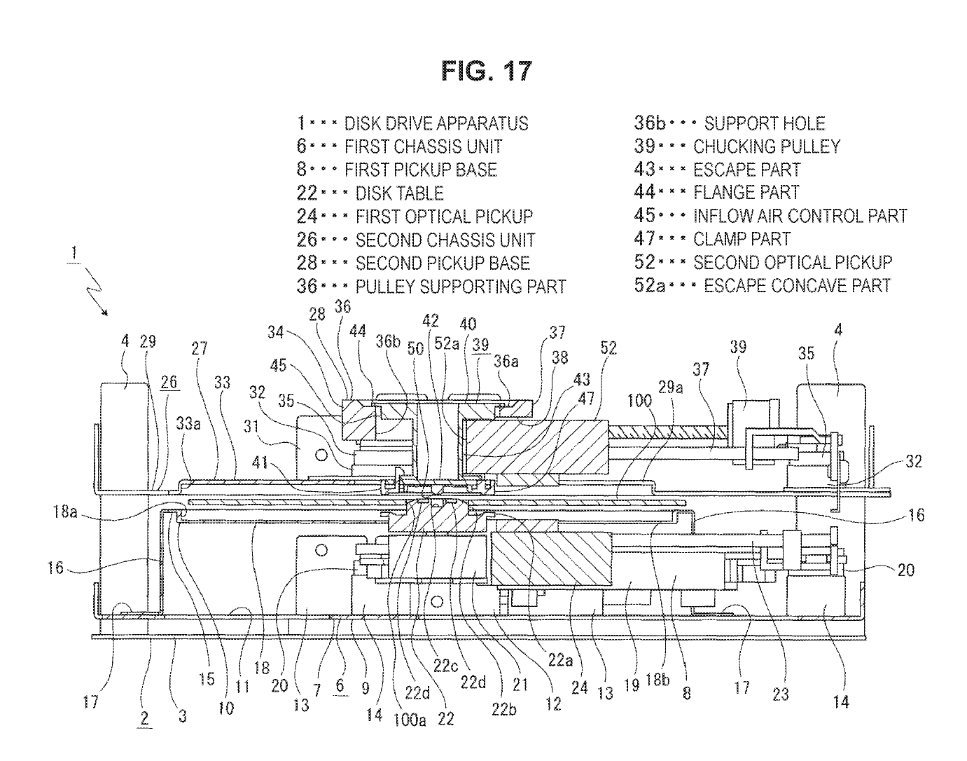

When the cam slider 54 is moved rearward, the guided pins 13a and 13a of the first chassis unit 6 are slid from the rear cam parts 55a and 55a toward the inclined cam parts 55b and 55b of the first cam holes 55 and 55, respectively, and also the guided pins 31a and 31a of the second chassis unit 26 are slid from the rear cam parts 56a and 56a toward the inclined cam parts 56b and 56b of the second cam holes 56 and 56, respectively (refer to FIG. 16). Accordingly, the first chassis unit 6 is moved upward and also the second chassis unit 26 is moved downward, the first rectifying plate part 18 of the first chassis unit 6 and the second rectifying plate part 33 of the second chassis unit 26 approach to each other, and also the disk table 22 and the chucking pulley 39 approach to each other (refer to FIG. 17).

The disk table 22 and the chucking pulley 39 approach to each other, and thereby the centering projection 22b of the disk table 22 is inserted in the center hole 100a of the disk-like recording medium 100 from a lower side. When the centering projection 22b of the disk table 22 is inserted in the center hole 100a of the disk-like recording medium 100, holding of the disk-like recording medium 100 by the disk holding part is released, and the disk holding part is, for example, retracted outside outer peripheries of the first rectifying plate part 18 and the second rectifying plate part 33.

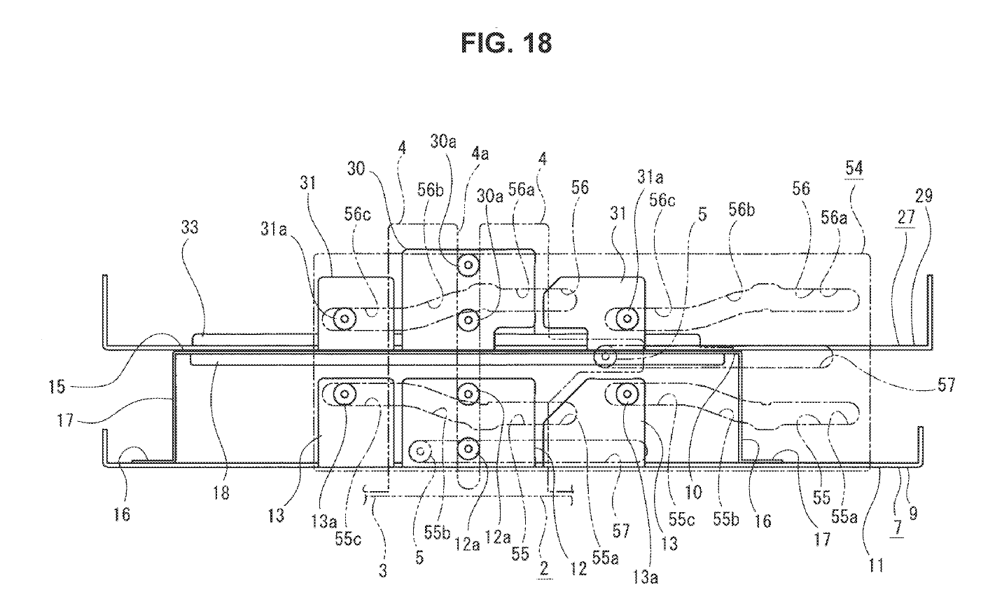

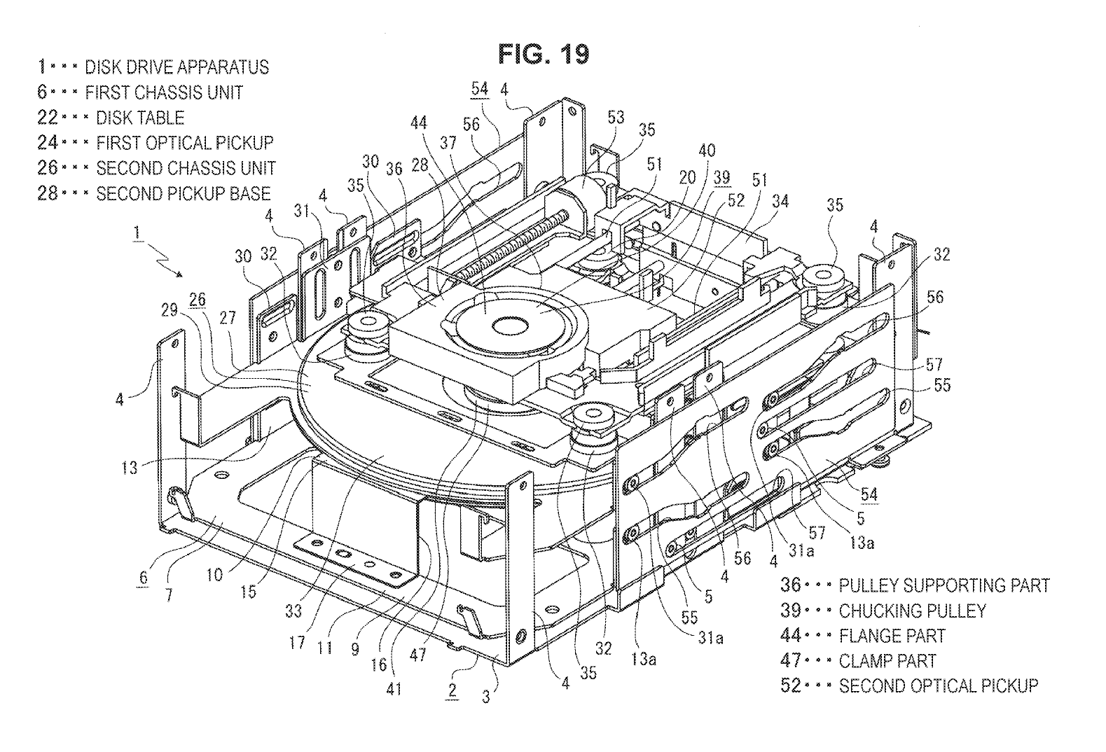

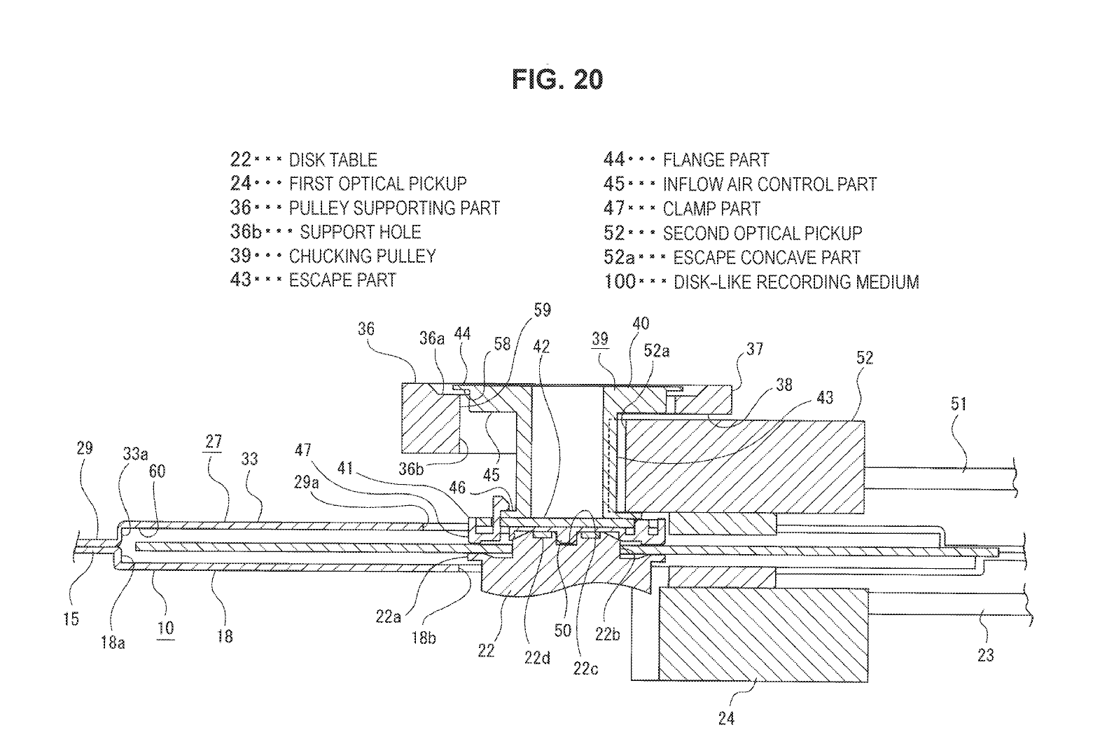

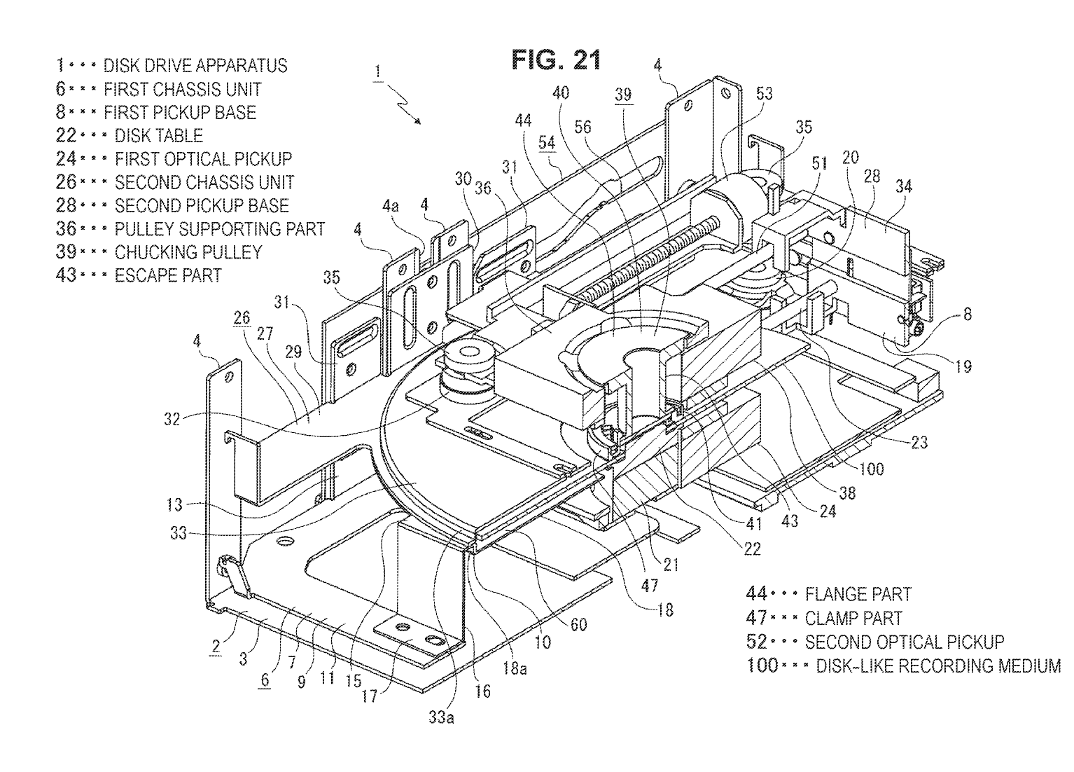

The cam sliders 54 and 54 are continuously moved rearward, the guided pins 13a and 13a of the first chassis unit 6 are slid from the inclined cam parts 55b and 55b to front ends of the front cam parts 55c and 55c of the first cam holes 55 and 55, respectively, and also the guided pins 31a and 31a of the second chassis unit 26 are slid from the inclined cam parts 56b and 56b to front ends of the front cam parts 56c and 56c of the second cam holes 56 and 56, respectively (refer to FIGS. 18 and 19). Accordingly, the first chassis unit 6 is moved further upward and also the second chassis unit 26 is moved further downward, and the first rectifying plate part 18 of the first chassis unit 6 and the second rectifying plate part 33 of the second chassis unit 26 further approach to each other, and also the disk table 22 and the chucking pulley 39 further approach to each other (refer to FIGS. 20 and 21).

When the disk table 22 and the chucking pulley 39 approach to each other, the positioning projection 50 provided at the clamper 41 of the chucking pulley 39 is inserted in the positioning concave part 22c formed in the centering projection 22b of the disk table 22, and positioning of the chucking pulley 39 and the disk table 22 is performed. The metal plate 22d of the disk table 22 is attracted by the magnet 42 provided at the chucking pulley 39 through an inner periphery of the disk-like recording medium 100, and thereby the disk-like recording medium 100 is chucked while the inner periphery thereof being sandwiched by the table part 22a of the disk table 22 and the clamp part 47 of the chucking pulley 39.

Note that in the disk drive apparatus 1, a magnet is provided at the disk table 22, a metal plate is provided at the chucking pulley 39 to be attracted by the magnet, and then chucking may be performed, or that the magnet is provided at both the disk table 22 and the chucking pulley 39, the both magnets are attracted to each other, and then chucking may be performed.

In a state where the disk-like recording medium 100 has been chucked while being sandwiched by the chucking pulley 39 and the disk table 22, the chucking pulley 39 is pushed up by the disk table 22, and the flange part 44 is located spaced aside upward from the bottom surface of the receiving concave part 36a formed in the pulley supporting part 36. Accordingly, an annular space is generated between the flange part 44 and the bottom surface of the receiving concave part 36a, and this space is formed as an air inflow space 58. In addition, an annular air flow space 59 communicated with the air inflow space 58 is formed between an upper end of the support hole 36b in the pulley supporting part 36 and the inflow air control part 45 of the chucking pulley 39.

When the disk-like recording medium 100 is chucked, rearward movement of the cam sliders 54 and 54 is stopped.

In a state where chucking of the disk-like recording medium 100 has been performed, an upper end of the first folded part 18a of the first rectifying plate part 18 and a lower end of the second folded part 33a of the second rectifying plate part 33 are butted against each other, whereby a housing space 60 is formed inside the first rectifying plate part 18 and the second rectifying plate part 33 by the first rectifying plate part 18 and the second rectifying plate part 33, and the disk-like recording medium 100 is stored in the housing space 60. At this time, the first rectifying plate part 18 is located at the disk-like recording medium 100 so as to be opposed to a lower surface and also the second rectifying plate part 33 is located so as to be opposed to an upper surface, and a constant gap exists between the lower surface of the disk-like recording medium 100 and the first rectifying plate part 18 and also a constant gap exists between the upper surface of the disk-like recording medium 100 and the second rectifying plate part 33. These gaps are, for example, all made as approximately 2 mm.

As described above, when the disk-like recording medium 100 is chucked, the disk table 22 is rotated by the drive force of the spindle motor 21, the disk table 22, the chucking pulley 39, and the disk-like recording medium 100 are integrally rotated, and also one or both of the first optical pickup 24 and the second optical pickup 52 is/are moved in a radial direction of the disk-like recording medium 100, and recording or reproduction of an information signal to the disk-like recording medium 100 is performed.

At this time, since as described above, a constant gap exists between the lower surface of the disk-like recording medium 100 and the first rectifying plate part 18 and also a constant gap exists between the upper surface of the disk-like recording medium 100 and the second rectifying plate part 33, an air flow of both upper and lower surface sides of the disk-like recording medium 100 is rectified, and surface shake does not easily occur in the disk-like recording medium 100.

In addition, although the air is made to flow in an outer peripheral side of the chucking pulley 39 from the air inflow space 58 formed between the flange part 44 and the bottom surface of the receiving concave part 36a, and is made to flow through the air flow space 59, both the air inflow space 58 and the air flow space 59 are formed in annular shapes, and thus the air made to flow in the air inflow space 58 and the air flow space 59 is rectified. Accordingly, inclination is hard to occur in the chucking pulley 39 to be rotated, the chucking pulley 39 is smoothly rotated, and the surface shake of the disk-like recording medium 100 that is rotated integrally with the chucking pulley 39 is even harder to occur.

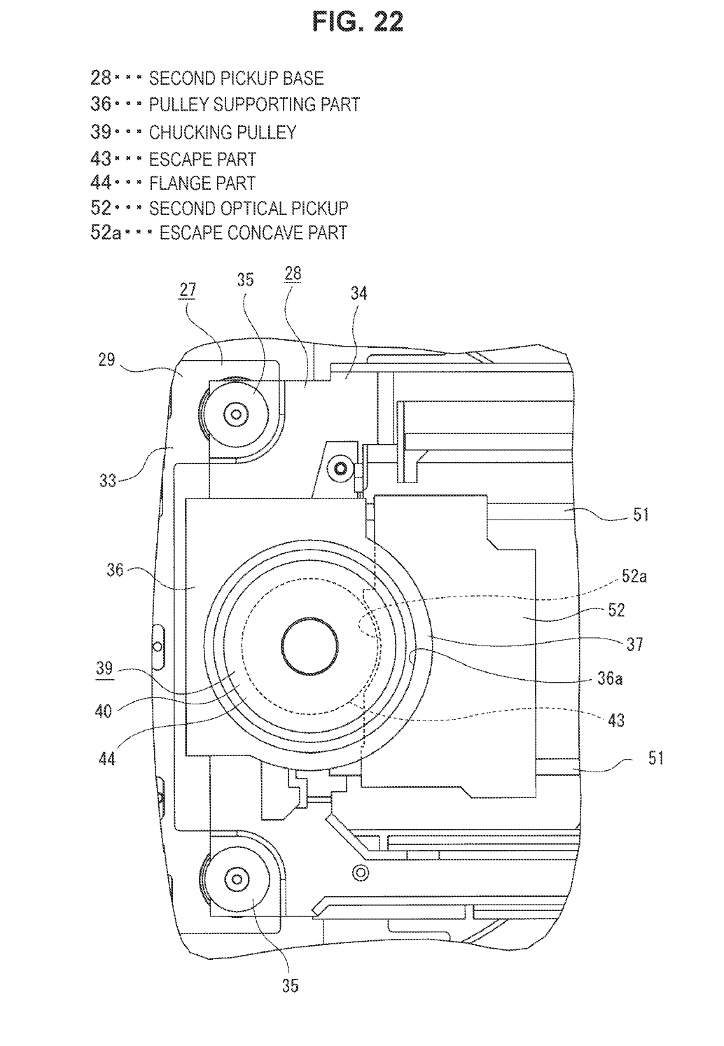

As described above, the second optical pickup 52 may be moved in the radial direction of the disk-like recording medium 100 when recording or reproduction of an information signal to the disk-like recording medium 100 is performed, but when the second optical pickup 52 is moved to an inner peripheral side of the disk-like recording medium 100, the second optical pickup 52 is inserted between the inflow air control part 45 and the clamp part 47 from the movement space 38 formed at an upper side of the projection 37, and a part of the escape part 43 of the chucking pulley 39 is inserted in the escape concave part 52a formed in the second optical pickup 52 (refer to FIG. 22).

Accordingly, movement of the second optical pickup 52 does not interfere with the chucking pulley 39, and contact of the second optical pickup 52 and the chucking pulley 39 is avoided.

When rotation of the disk-like recording medium 100 is stopped, and recording or reproduction of the information signal to the disk-like recording medium 100 is ended, the cam sliders 54 and 54 are moved forward by the drive mechanism, the guided pins 13a and 13a of the first chassis unit 6 are slid from front ends of the front cam parts 55c and 55c to rear ends of the rear cam parts 55a and 55a of the first cam holes 55 and 55, respectively, and also the guided pins 31a and 31a of the second chassis unit 26 are slid from front ends of the front cam parts 56c and 56c to rear ends of the rear cam parts 56a and 56a of the second cam holes 56 and 56, respectively. Accordingly, the first chassis unit 6 is moved downward and also the second chassis unit 26 is moved upward, and the first rectifying plate part 18 of the first chassis unit 6 and the second rectifying plate part 33 of the second chassis unit 26 are spaced aside from each other. In addition, the disk table 22 and the chucking pulley 39 are spaced aside from each other, and chucking to the disk-like recording medium 100 is released.

The disk-like recording medium 100 is held again by the disk holding part of the conveyance device, is conveyed in a discharge direction (forward) by the conveyance device, and is stored in the disk cartridge.

### CONCLUSION

As described above, in the disk drive apparatus 1, the escape part 43 to avoid interference with the second optical pickup 52 is provided at the chucking pulley 39 supported by the pulley supporting part 36.

Accordingly, interference of the chucking pulley 39 and the second optical pickup 52 is avoided and also a movement space of the second optical pickup 52 is increased, and reduction in size can be achieved and also simplification of a structure of the chucking pulley 39 can be achieved after interference of the chucking pulley 39 and the second optical pickup 52 is avoided and a desired movement range of the second optical pickup 52 is secured.

In addition, the annular inflow air control part 45 to control the air made to flow in the support hole 36b is provided at the chucking pulley 39.

Accordingly, the uniform air in the peripheral direction is made to flow in the support hole 36b from the air inflow space 58, a flow of the air around the chucking pulley 39 is rectified, and a stable rotational state of the chucking pulley 39 can be secured.

Furthermore, in the chucking pulley 39, the escape part 43 and the clamp part 47 are made removable, a diameter of the escape part 43 is made smaller than the diameter of the support hole 36b, and an outer shape of the clamp part 47 is made larger than the diameter of the support hole 36b.

Accordingly, the escape part 43 is inserted in the support hole 36b in a state where the escape part 43 and the clamp part 47 are separated from each other, and the clamp part 47 is connected to the escape part 43, whereby the chucking pulley 39 is supported by the pulley supporting part 36, and improvement in workability in assembly work of the chucking pulley 39 to the pulley supporting part 36 can be achieved.

Furthermore, the escape part 43 of the chucking pulley 39 is formed in a cylindrical shape or a columnar shape that extends in a thickness direction of the disk-like recording medium 100, and the circular arc-shaped escape concave part 52a is formed in the second optical pickup 52.

Accordingly, reduction in size of the disk drive apparatus 1 can be achieved after the movement range of the second optical pickup 52 is increased.

In addition, since the flange part 44 and the inflow air control part 45 are integrally formed in the chucking pulley 39, reduction in manufacturing cost due to reduction in the number of components can be achieved.

In addition to that, since the inflow air control part 45 and the escape part 43 are integrally formed in the chucking pulley 39, further reduction in manufacturing cost due to further reduction in the number of components can be achieved.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) A disk drive apparatus including:

a first chassis unit that has a first pickup base at which a first optical pickup has been disposed; and

a second chassis unit that has a second pickup base at which a pulley supporting part has been provided and at which a second optical pickup has been disposed,

wherein a disk table on which a disk-like recording medium is loaded is disposed at the first pickup base,

wherein a support hole is formed in the pulley supporting part,

wherein a chucking pulley that sandwiches and holds the disk-like recording medium together with the disk table is supported by the pulley supporting part in a state of being inserted in the support hole, and
wherein, at the chucking pulley, provided are an escape part to avoid interference with the second optical pickup, a flange part that is overhung outward from one end in an axial direction and that restricts fall-off from the support hole, and a clamp part that is overhung outward from another end in the axial direction and that is pressed against an inner periphery of the disk-like recording medium.
(2) The disk drive apparatus according to (1), wherein at the chucking pulley, provided is an annular inflow air control part that is located in the support hole and that controls the air made to flow in the support hole in a state where the disk-like recording medium is sandwiched by the disk table and the chucking pulley.
(3) The disk drive apparatus according to (2),

wherein the escape part and the clamp part are made removable,

wherein a diameter of the escape part is made smaller than a diameter of the support hole, and

wherein an outer shape of the clamp part is made larger than the diameter of the support hole.
(4) The disk drive apparatus according to any one of (1) to (3),

wherein the escape part is formed in a cylindrical shape or a columnar shape that extends in a thickness direction of the disk-like recording medium, and

wherein a circular arc-shaped escape concave part that is opposed to the escape part is formed in the second optical pickup.
(5) The disk drive apparatus according to any one of (1) to (4), wherein the flange part and the inflow air control part are integrally formed.
(6) The disk drive apparatus according to (5), wherein the inflow air control part and the escape part are integrally formed.

What is claimed is:

1. A disk drive apparatus comprising:
a first chassis unit that has a first pickup base at which a first optical pickup has been disposed; and
a second chassis unit that has a second pickup base at which a pulley supporting part has been provided and at which a second optical pickup has been disposed,
wherein a disk table on which a disk-like recording medium is loaded is disposed at the first pickup base,
wherein a support hole is formed in the pulley supporting part,
wherein a chucking pulley that sandwiches and holds the disk-like recording medium together with the disk table is supported by the pulley supporting part in a state of being inserted in the support hole, and
wherein, at the chucking pulley, provided are an escape part to avoid interference with the second optical pickup, a flange part that is overhung outward from one end in an axial direction and that restricts fall-off from the support hole, and a clamp part that is overhung outward from another end in the axial direction and that is pressed against an inner periphery of the disk-like recording medium.

2. The disk drive apparatus according to claim 1, wherein at the chucking pulley, provided is an annular inflow air control part that is located in the support hole and that controls the air made to flow in the support hole in a state where the disk-like recording medium is sandwiched by the disk table and the chucking pulley.

3. The disk drive apparatus according to claim 1,
wherein the escape part and the clamp part are made removable,
wherein a diameter of the escape part is made smaller than a diameter of the support hole, and
wherein an outer shape of the clamp part is made larger than the diameter of the support hole.

4. The disk drive apparatus according to claim 1,
wherein the escape part is formed in a cylindrical shape or a columnar shape that extends in a thickness direction of the disk-like recording medium, and
wherein a circular arc-shaped escape concave part that is opposed to the escape part is formed in the second optical pickup.

5. The disk drive apparatus according to claim 2, wherein the flange part and the inflow air control part are integrally formed.

6. The disk drive apparatus according to claim 5, wherein the inflow air control part and the escape part are integrally formed.
